(19) United States
(12) Patent Application Publication
(10) Pub. No.: US 2022/0299420 A1
(43) Pub. Date: Sep. 22, 2022

(54) SYSTEMS AND METHODS FOR IMAGE CYTOMETRY

(71) Applicant: The Regents of the University of California, Oakiand, CA (US)

(72) Inventors: Bo Huang, San Francisco, CA (US); Dan Xie, San Francisco, CA (US)

(21) Appl. No.: 17/638,657

(22) PCT Filed: Aug. 28, 2020
(86) PCT No.: PCT/US2020/048403

§ 371 Date: Feb. 25, 2022

Related U.S. Application Data
(60) Provisional application No. 62/894,060, filed on Aug. 30, 2019.

(51) Int. Cl. G01N 15/14; G02B 21/00

(52) U.S. Cl. CPC G01N 15/147; G02B 21/0076; G01N 2015/1006

(57) ABSTRACT

The present disclosure describes image cytometry methods and systems. One such system comprises an illumination subsystem configured to generate a thin sheet of light; a scanning subsystem configured to move the sheet of light across a threedimensional suspension medium that contains cells or other objects; and an imaging subsystem configured to receive light reflected and/or emitted by the cells/objects.

### CROSS-REFERENCE TO RELATED APPLICATION

This application claims priority to co-pending U.S. provisional application entitled, “SYSTEMS AND METHODS FOR IMAGE CYTOMETRY,” having Ser. No. 62/894,060, filed Aug. 30, 2019, which is entirely incorporated herein by reference.

### NOTICE OF GOVERNMENT-SPONSORED RESEARCH

This invention was made with Government support under grant contract no. R21 GM129652 awarded by the National Institutes of Health. The Government has certain rights in the invention.

### TECHNICAL FIELD

The present disclosure is generally related to cytometry.

### BACKGROUND

Cytometry is the measurement of cell parameters, such cell count, cell morphology, cell cycle phase, and the like. Cytometry is widely used in both biomedical research and clinics for its fundamental importance in analyzing individual cells contained within a specimen. Although cytometry started with simple manual cell counting under a light microscope with cells spread out on the surface of a substrate, it is still a standard practice in cell culture and in diagnosis of blood samples.

Flow cytometry is a more recent cytometry technique. In flow cytometry, a sample containing cells is suspended in a fluid and injected into a flow cytometer with which individual cells are “flowed” past a laser beam and the light scattered by the cells is used to characterize the cells. As compared to manual counting, flow cytometry dramatically increases the throughput and nicely integrates cytometry with automated sample handling. With a strong excitation intensity, sufficient scattering and fluorescence signals can be accumulated on the time scale of microseconds, enabling extremely fast cell counting.

In view of the benefits provided by flow cytometry, flow cytometry has been utilized in many applications in basic research (particularly in the fields of stem cell, immunology, and cancer), drug discovery (e.g., high-throughput screening), biological engineering, and medical diagnostics (it is now the standard practice of counting white blood cell types). Although flow cytometry is useful in detecting an abundance of labeled markers, it cannot provide any spatial information, which reveals cell morphology and subcellular distribution markers. Only limited information on cell morphology (e.g., size) can be inferred from the forward- and side-scattered signal.

Image-based cytometry, now referred to as image cytometry, on the other hand, can provide much richer information regarding the sample. Modern image cytometry has been demonstrated mostly in two approaches. The first approach is an automated and streamlined version of the original microscope-based cytometry, with cells either forming a monolayer at the bottom of a plate or suspended and injected into a thin channel so that all the cells in the field of view are in focus during image acquisition. In the second approach, an image detector is used in a flow system similar to existing flow cytometers. Both approaches, however, provide much lower throughput as compared to conventional flow cytometry. Furthermore, the first approach is constrained by the need to spread the cells out to form a single, two-dimensional layer, while the second approach is limited by sequential imaging of individual cells.

In view of the above discussion, it can be appreciated that it would be desirable to have systems and methods for performing image cytometry that do not suffer from the drawbacks of currently available systems and methods.

### SUMMARY

Embodiments of the present disclosure provide image cytometry methods and systems. One such system comprises an illumination subsystem configured to generate a thin sheet of light; a scanning subsystem configured to move the sheet of light relative to a three-dimensional suspension medium that contains cells or other non-cell objects; and an imaging subsystem configured to receive light reflected, refracted, scattered and/or emitted by the cells/objects.

In one or more aspects, the illumination subsystem comprises an illumination objective; the scanning subsystem comprises a movable microscope stage; the imaging subsystem comprises an imaging objective; and/or the system is configured as a selective plane illumination microscopy (SPIM) system.

Aspects of the present disclosure are also related to an exemplary method performing in situ image cytometry of a sample contained in a tube. Such a method comprises creating a suspension of a sample to be evaluated in a tube; scanning a thin sheet of light along the suspension; receiving light reflected and/or emitted by objects within the suspension; and capturing images of the received light as the sheet of light is scanned.

In one or more aspects, the objects are cells; the tube is a cylindrical tube; the tube includes a planar imaging window; the tube has a planar bottom; the tube has a planar side; the light sheet is perpendicular to a longitudinal axis of the tube; the light sheet is at an approximate 45 degree angle to a longitudinal axis of the tube; the receiving light comprises receiving light from below the imaging chamber; the receiving light comprises receiving light from a side of the imaging chamber; and/or the images are captured at discrete positions along the suspension medium as the sheet of light is scanned.

In one or more aspects, method operations may further include centrifuging the sample while within the tube prior to scanning; placing the tube within an imaging chamber that contains an index-matching medium; processing the images to identify shapes and/or signal intensities of the objects in the suspension of the tube; and/or processing the images to count a number of the objects in the suspension of the tube.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

The present disclosure may be better understood with reference to the following figures. Matching reference numerals designate corresponding parts throughout the figures, which are not necessarily drawn to scale.

FIG. 1 is a schematic diagram illustrating the principle of image cytometry for cells contained within a three-dimensional suspension.

FIG. 2(a) is a schematic diagram of an image cytometry system.

FIG. 2(b) is a schematic diagram of images (a raw z-stack) captured using the system of FIG. 2(a) and processing of those images including de-skewing.

FIG. 3 is a static (non-scanned) fluorescence image of cells captured using the system of FIG. 2(a).

FIG. 4(a) is an image of raw data obtained using the system of FIG. 2(a).

FIG. 4(b) is a graph that plots cell volume analysis results for the cells shown in FIG. 4(a).

FIG. 4(c) is a graph that plots cell intensity analysis results for the cells shown in FIG. 4(a).

FIGS. 5(a)-5(f) are schematic diagrams of various alternative configurations for an image cytometry system that can be used to evaluate a sample suspended in a tube container.

### DETAILED DESCRIPTION

As described above, it would be desirable to have systems and methods for performing image cytometry that do not suffer from the drawbacks of conventional techniques. Disclosed herein are examples of such systems and methods. In one embodiment, an image cytometry system comprises an illumination subsystem configured to generate a thin sheet of light that can be scanned across a three-dimensional suspension medium that contains cells or other objects, and an imaging subsystem configured to receive light reflected and/or emitted by the cells/objects. Multiple images of the three-dimensional suspension medium can be obtained at various discrete positions along the suspension medium and the images can be processed for purposes of cytometry. Such processing can include counting the number of cells/objects in the suspension medium as well as characterizing the nature of the cells/objects.

In the following disclosure, various specific embodiments are described. It is to be understood that those embodiments are example implementations of the disclosed inventions and that alternative embodiments are possible. Such alternative embodiments include hybrid embodiments that include features from different disclosed embodiments. All such embodiments are intended to fall within the scope of this disclosure.

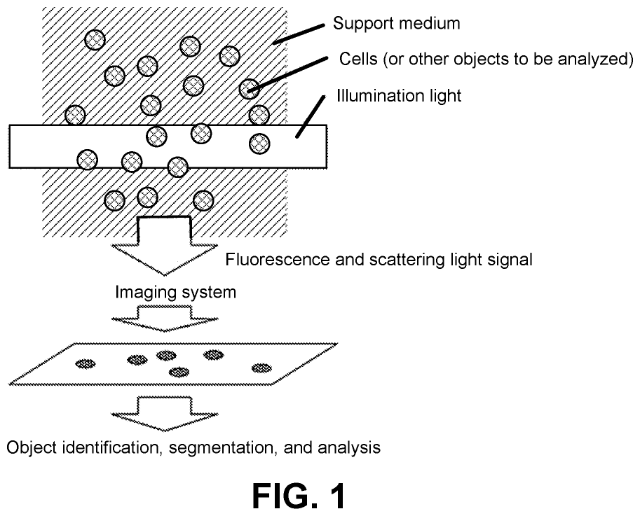

In a study conducted by the inventors, it was proved that imaging can be performed on cells suspended or otherwise supported in a three-dimensional dispersion state. This is schematically illustrated in FIG. 1. As shown in that figure, cells (or other objects to be counted or analyzed) are suspended within a support medium. A sheet of illumination light is then scanned across the support medium and fluorescence and scattered light can be collected by an imaging system. The image data can then be analyzed using appropriate software to identify the cells/objects, segment the cells/objects, count the cells/objects, and otherwise analyze the cells/objects. Specific examples of such a system are disclosed, for example, in U.S. Pat. No. 10,139,608 (“the '608 patent”), which is hereby incorporated by reference into the present disclosure in its entirety.

The system described in the '608 patent is specifically configured to perform light sheet microscopy, also known as selective plane illumination microscopy (SPIM). In light sheet microscopy, the illumination light (in one or multiple wavelengths) is delivered into a cell suspension and confined to a volume that is relatively wide in the x and y directions but relatively narrow in the z direction, thereby creating a “sheet” of light that can be scanned across the suspension. An optical imaging system captures wide-field images of the cells with the focal plane matching the light sheet, including both the fluorescence signals (with an emission filter to block the illumination light) and the side-scattering signals (without the emission filter). Imaging of cells throughout the volume of the suspension can be achieved by capturing multiple discrete images while scanning the light sheet (and the imaging plane), moving the sample holder, and/or flowing the cells across the light sheet.

These images can then be analyzed to identify individual cells to extract information, such as the positions of the cells in the suspension, the shapes of cells, the signal intensities of markers, and the subcellular distributions of the labeled markers. The relative position of different cells can further be used to reveal interactions between cells. Accordingly, such a system enables three-dimensional image cytometry, which is not possible with existing cytometry systems. Furthermore, unlike flow cytometry systems, in which the cell sample must be removed from its original container, this three-dimensional image cytometry can be performed in situ so that analysis can be conducted without disrupting the cell analyte, thereby enabling further handling and/or repetitive readouts in order to record a time trajectory of a biological process.

In addition to cell cytometry, a SPIM system such as that described in the '608 patent can also be utilized for high throughput analysis of other suspended objects, such as beads (e.g., polymer beads that have captured certain analytes) and droplets (e.g., for the analysis of droplet polymerase chain reaction (PCR) results in which PCR reactions have been performed in small aqueous droplets).

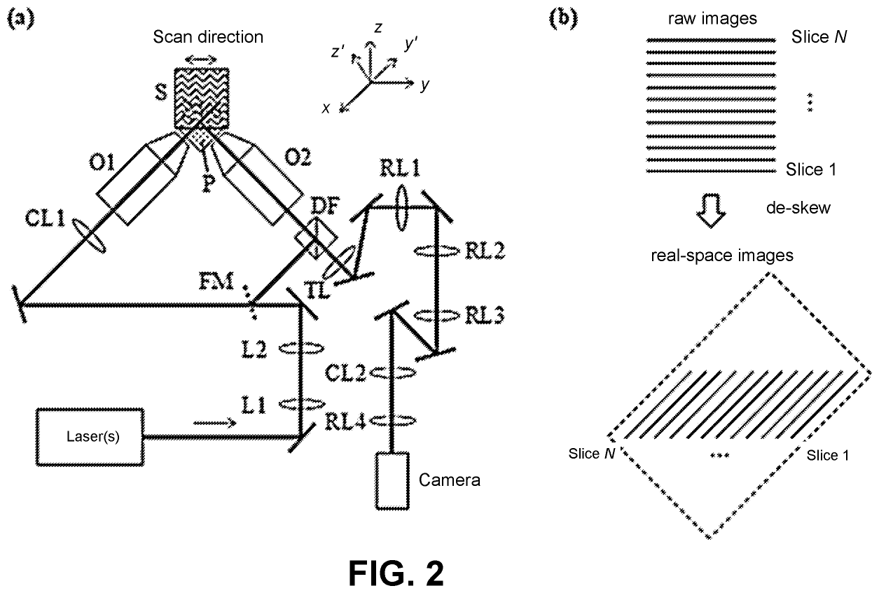

FIG. 2(a) illustrates an embodiment of an image cytometry system that is based on a SPIM configuration in which samples within well plates can be evaluated in situ. This system comprises two major components: an open-top selective plane illumination microscopy (OT-SPIM) platform configured to perform fast scan of cell samples in the suspension (see FIG. 2(a)), and an image processing pipeline configured to perform cell segmentation, fluorescence intensity calculation, and quantitative analysis of cell properties (not shown).

In one example configuration for the system shown in FIG. 2(a), the imaging head comprises a pair of 0.25 NA objectives, O1 and O2 (Olympus, RMS10X, 10.6 mm WD). An expanded laser beam (coherent OBIS LS 488/561) enters the microscope via the illumination path on the left in the figure. Through the combination of a cylindrical lens, CL1, and the illumination (excitation) objective, O1, the laser beam forms a thin light sheet at the imaging plane of the imaging objective, O2, and illuminates fluorophores within the sample. To minimize optical aberration and refraction of the light sheet induced by the layer of cover glass supporting the specimens, a coupling water prism, P, is inserted between the two objectives to create water-glass-air interfaces perpendicular to the optical axes of the objectives. Signals can be collected with the image objective, O2, and directed by a series of relay optics to a scientific CMOS camera (Hamamatsu Flash Orca 4.0). The camera can capture the scattered illumination light if the dichroic filter, DF, is removed. The calibrated imaging pixel size is =0.4 microns, leading to an approximately 0.8 mm wide effective field of view (2,048 pixels in each dimension). Other components identified in FIG. 2(a) include a second cylindrical lens, CL2, a flip mirror, FM, beam expansion lenses, L1 and L2, a tube lens, TL, and relay lenses, RL1, RL1, RL3, and RL4. The lab frame and the imaging frame are represented in FIG. 2(a) by x-y-z and x, y′, z′, respectively.

The cell sample can be mounted on a motorized XY stage (Marzhauser). While all the optical components are installed in a fixed manner, volumetric imaging can be accomplished by moving the sample across the illumination light sheet. The scan can be implemented by moving the sample along the y-axis in the lab frame. Since the scan direction is oriented at an angle of 45° with respect to the imaging direction (z′), the raw image stacks can be skewed but can be de-skewed in the image processing steps, which are depicted in FIG. 2(b). To ensure fast scans, video acquisition and stage motion can be conducted simultaneously without synchronization. Given the constant frame rate and the stage velocity (except the acceleration/deceleration phases), one may assume a simple linear relationship between the sample position and the elapsed time. The simultaneous operation of the stage and the camera can be accomplished either through multi-threaded processes using a program such as Micro-Manager™, or directly through control software of the two devices.

In experiments performed using the system shown in FIG. 2(a), HEK 293T cells were cultured, stained with a membrane dye, suspended in media by trypsin treatment, and added to coverglass-bottomed 8-well chamber, and stacks of images were captured after placing the chambers on the scanning stage. The stage was scanned at 0.4 mm/s while images were acquired at 20 fps.

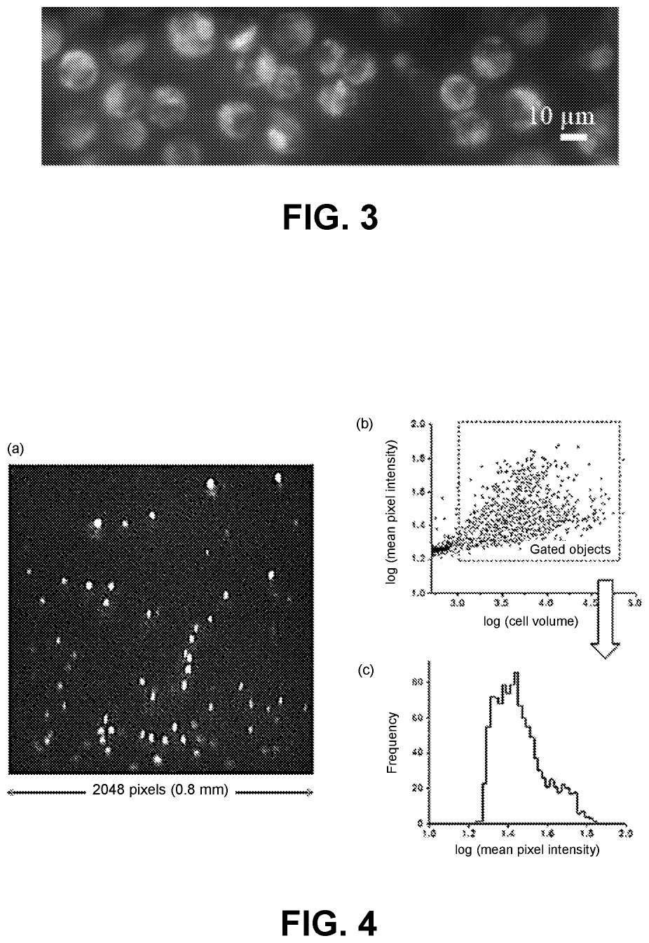

FIG. 3 is a static image acquired using the system of FIG. 2(a). The cells sank to the bottom of the well and piled up. As is clear from this image, the image cytometry system has the resolution to reveal the subcellular distribution of the fluorescence signal and is capable of optical sectioning to distinguish cells lying on top of each other.

Analysis of cell size and cell fluorescence intensity can be performed on the data set acquired during scanning. To calibrate the absolute volume so that one can obtain an absolute cell density count, the scanned distance can be calculated using the following relation

D=NvΔt,

in which N is the total number of slices after truncation, v is the stage velocity, and Δt is the exposure time of each slice. In principle, the de-skewed stack can be calculated based on D, N, and the pixel size Δx. Practically, because the scanned sample usually forms a long and thin volume, i.e., spans a long distance in y and short distance in z, a direct de-skew would lead to enormous image stacks largely padded with zero, which can be inconvenient for analysis and storage. Since the images are usually sparse in features (well separated cells), instead of de-skewing the raw image stacks, one can instead extract cells from each slice of raw images (FIG. 4(a)) and de-skew their coordinates. It is noted that the data set presented in FIG. 4(a) has a motion blur along the y axis because of the fast scanning speed that was used during image acquisition. The inventors have demonstrated that the motion blur can be resolved with strobed illumination light having very short exposure times but high peak intensities.

Cells in the image stack were next identified using the following steps: (1) background subtraction in each slice using the ball-rolling algorithm (ball radius=50 pixels), (2) noise suppression with Gaussian blur (Gaussian radius=4 pixels), and (3) three-dimensional object identification (ImageJ 2.0 plug-in, threshold=15 camera counts).

FIG. 4(b) shows the analysis results for 200 slices of a sample (analyzed volume=0.82 (x)×4.0 (y)×0.58 (z) mm³=1.9 μL). After gating on the particle volume cleanly rejected cell debris as small, dim particles, as well as cell clusters as overly large particles, a total cell count of 1116 was obtained, corresponding to an absolute density of 6×10⁵ mL⁻¹. The histogram of the mean pixel fluorescence intensity of counted cells, which is commonly used to visualize one channel flow cytometry data, can then be plotted as in FIG. 4(c).

It is noted that, in other embodiments, multiple illumination laser wavelengths and/or multiple detection channels (e.g., using multiple cameras separated by different dichroic and emission filter combinations) can be used to enable the simultaneous measurement of multiple marks from the same cell sample. It is further noted that dark-field (side-scattering) images of the cells can be acquired by illuminating the sample from the side at a wavelength that will pass through the emission dichroic filter and emission filters.

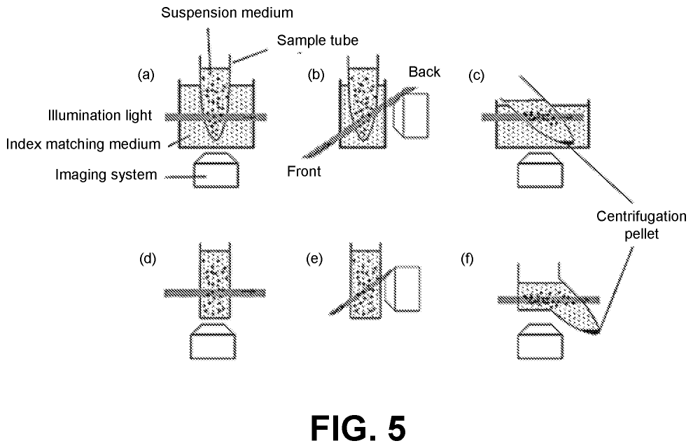

In addition to cells in well plates, the disclosed image cytometry can be performed in situ in relation to cells in tubes, such as centrifugation tubes and PCR tubes, in order to simplify sample handling. For conventional tubes having a round cross-section, the refractive index mismatch between the suspension media (which may be close to water) and the air outside of the tube creates a lensing effect that can deteriorate the quality of the illumination light sheet as well as the detected images. This issue can be overcome by placing the tube in an imaging chamber filled with index-matching media so that the refractive index difference between the inside and the outside of the tube is reduced. Examples of this are illustrated in FIGS. 5(a)-5(c). In these examples, the imaging chamber contains clear, planar windows for the illumination light to enter the chamber, and for the scattered and fluorescence light to exit the chamber and enter the imaging system. The imaging system can be placed either at the bottom of the imaging chamber in an upright configuration, as shown in FIG. 5(a), or at the side the imaging chamber in a sideways configuration, as shown in FIG. 5(b). Placing the imaging system at the bottom of the imaging chamber, as shown in FIG. 5(c), enables easy scanning across the entire depth of the tube, although this configuration also may have larger negative impact on the imaging quality due to the shape of the tube.

Because the walls of the tubes are typically made of polypropylene or polystyrene plastic, which has a different refractive index than water, the curved tube wall in the imaging patch can potentially induce optical aberration. It has been determined, however, that conventional PCR tubes create only minor optical aberrations that can be well tolerated because their walls are sufficiently thin. Alternatively, tubes can be fabricated with special wall material that has a refractive index closer to that of the suspension medium.

In another implementation, tubes having integrated imaging windows (a clear, planar surface) can be used. FIGS. 5(d)-5(f) show examples of this. In each of those configurations, image cytometry may be performed without the need of an imaging chamber or an index-matching medium. For example, cylindrical tubes having a planar bottom surface can be used in the upright configuration with the imaging optics at the bottom (FIGS. 5(d) and 5(f)). Tubes with a square cross-section can be used in the sideways configuration with the imaging optics on the side of the tube (FIG. 5€).

Direct image cytometry in tubes as shown in FIG. 5 is of particular advantage when coupled to sample pre-treatment by centrifugation. For example, when analyzing white blood cells in a blood sample, centrifugation is first performed to separate out the red blood cells, which consists of the majority of blood cells and has high light absorption from hemoglobin. After centrifugation with a density cushion, red blood cells will form pellets at the bottom of the tube and white blood cells will be concentrated in the middle of the tube. Image cytometry analysis of white blood cells can then be performed in the sideways configuration (FIGS. 5(b) and 5(e)) or the upright configuration (FIGS. 5(c) and 5(f)). In the latter case, the centrifugation tube can be oriented at an angle with respect to the detection light path so that the pellets will not block the light. This arrangement can be achieved either in an imaging chamber (e.g., FIG. 5(c)) or using a tube having an imaging window (FIG. 5(f)).

It should be emphasized that the above-described embodiments of the present disclosure are merely possible examples of implementations, merely set forth for a clear understanding of the principles of the present disclosure. Many variations and modifications may be made to the above-described embodiment(s) without departing substantially from the principles of the present disclosure. All such modifications and variations are intended to be included herein within the scope of this disclosure and protected by the following claims.

1. A system comprising:
an illumination subsystem configured to generate a thin sheet of light;
a scanning subsystem configured to move the sheet of light across a three-dimensional suspension medium that contains cells or other objects; and
an imaging subsystem configured to receive light reflected and/or emitted by the cells or other objects.

2. The system of claim 1, wherein the illumination subsystem comprises an illumination objective.

3. The system of claim 1, wherein the scanning subsystem comprises a movable microscope stage.

4. The system of claim 1, wherein the imaging subsystem comprises an imaging objective.

5. The system of claim 1, wherein the system is configured as a selective plane illumination microscopy (SPIM) system.

6. A method for performing in situ image analysis of a sample contained in a tube, the method comprising:
creating a suspension of a sample to be evaluated in a tube;
scanning a thin sheet of light along the suspension;
receiving light reflected and/or emitted by objects within the suspension; and
capturing images of the received light as the sheet of light is scanned.

7. The method of claim 6, wherein the objects are cells.

8. The method of claim 6, wherein the tube is a cylindrical tube.

9. The method of claim 8, wherein the tube includes a planar imaging window.

10. The method of claim 6, further comprising centrifuging the sample while within the tube prior to scanning.

11. The method of claim 6, further comprising placing the tube within an imaging chamber that contains an index-matching medium.

12. The method of claim 11, wherein receiving light comprises receiving light from below the imaging chamber.

13. The method of claim 11, wherein receiving light comprises receiving light from a side of the imaging chamber.

14. The method of claim 6, wherein the tube has a planar bottom.

15. The method of claim 6, wherein the tube has a planar side.

16. The method of claim 6, wherein the light sheet is perpendicular to a longitudinal axis of the tube.

17. The method of claim 6, wherein the light sheet is at an approximate 45 degree angle to a longitudinal axis of the tube.

18. The method of claim 6, wherein the images are captured at discrete positions along the suspension medium as the sheet of light is scanned.

19. The method of claim 18, further comprising processing the images to identify shapes or signal intensities of the objects in the suspension of the tube.

20. The method of claim 18, further comprising processing the images to count a number of the objects in the suspension of the tube.
